(19) United States
(12) Patent Application Publication
(10) Pub. No.: US 2002/0116297 A1
(43) Pub. Date: Aug. 22, 2002

(54) Method and apparatus for providing a virtual tour of a dormitory or other institution to a prospective resident

(76) Inventor: Sharl B. Olefson, Fort Lauderdale, FL (US)

Correspondence Address: Allen M. Krass, Gifford, Krass, Groh, Sprinkle,, Anderson & Citkowski, P.C., 280 N. Old Woodward, Suite 400, Birmingham, MI, 48009, US

(21) Appl. No.: 10/062,897

(22) Filed: Jan. 31, 2002

Related U.S. Application Data
(63) Continuation-in-part of application No. 09/789,577, filed on Feb. 22, 2001.
Application No. 09/789,577 is a continuation-in-part of application No. 08/664,164, filed on Jun. 14, 1996.

(51) Int. Cl. G06F 17/60

(52) U.S. Cl. 705/27

(57) ABSTRACT

The subject invention provides a prospective resident of a dormitory, or other new environment, with an interactive system for use by a virtual community in which the website is adapted to assist a member of the virtual community in the transition to living on a college campus or other new living environment. The website provides a member with a virtual tour of the college campus and a plurality of interactive features that are adapted to make the transition to living in the new environment more enjoyable.

### REFERENCE TO RELATED APPLICATION

This application is a continuation-in-part of U.S. patent application Ser. No. 09/789,577 filed Feb. 22, 2001, which is a continuation-in-part of U.S. patent application Ser. No. 08/664,164 filed Jun. 14, 1996, the entire contents of both applications being incorporated herein by reference.

### FIELD OF THE INVENTION

The invention relates generally to computer animation and in particular to an apparatus for generating, selecting and viewing visual representations of a new environment, particularly a new living environment such as a college campus or other institution.

### BACKGROUND OF THE INVENTION

The most difficult challenge facing college and university freshmen is the transition from living at home to living at school. Freshmen are mailed an enrollment package containing course registration and dormitory selection materials. Dormitory information is typically limited to the number of students per room and the number of rooms in each building so that a student is not actually able to see and/or recall a dormitory they may have visited during a campus tour. Consequently, making a knowledgeable decision is difficult, thereby adding to the anxiety and unknowns involved in going away to college.

Another challenge involves meeting immediate needs once freshmen arrive at their selected dormitory. These needs include bedding, desk and floor lamps, window treatments, small appliances, mirrors, decorations, a place to shop, job listings, etc. All of this confusion occurs at a time when freshmen are deeply absorbed with the emotional stress and time demands of school orientations, getting to know an entirely new set of friends, sorority/fraternity rushing, learning their way around campus and attending classes.

In most instances, freshmen have limited means of transportation and are completely unfamiliar with the roads and areas. In short, freshmen have no time, no way to get to, and no idea where to find stores in which to purchase these immediate needs, no less shop for their favorite brands or colors or for the best prices.

### SUMMARY OF THE INVENTION

The subject invention provides an interactive system for a prospective resident of a dormitory or other new environment, with an internet website adapted to assist a member of a virtual community in the transition to a college campus or other new living environment. The new environments may be temporary or permanent living/working environments such as college campuses, assisted living facilities, resorts, or similar residences, office buildings, etc.

In the case of a college campus, links will be provided for some or all of its dormitories so that prospective residents can actually see each dormitory before making their housing selection. Preferably, the website provides a member with a virtual tour of the environment and a plurality of interactive features that are adapted to assist the member in making the transition to the new environment. The invention is made available via CD-ROM or floppy disc though in the preferred embodiment, online via an internet, intranet, or extranet website. An on-line tour of a prospective new environment is 360° spherical and/or stereoscopic and includes a plurality of other features that allows the member to quickly obtain information about everything they need and want to know about their potential new surroundings.

Additionally, the website provides a plurality of interactive features that include a member menu and an interactive checklist including substantially everything a prospective resident of a new environment will need to do during the transition period and additional things a member may want to do to make the transition a more enjoyable experience.

Further, the internet website provides merchants with an efficient and convenient means to advertise their products and services to website members. Links are provided to merchant websites where members can e-shop and purchase items and have them delivered to a desired location. The links direct the member to the item they are looking for at the merchant's website and, once at the merchant's website, are presented with links to other items offered by the merchant that they may be interested in purchasing. This makes e-shopping convenient for the member while providing the merchant with the potential benefit of selling additional items. Also, merchants are provided a special authorization that allows them to update advertisements on the website as desired.

### BRIEF DESCRIPTION OF THE DRAWINGS

The present invention will be better understood by reference to the following detailed description in conjunction with the accompanying drawings in which like reference characters refer to like parts throughout the several views in which:

FIG. 1 is a pictorial representation of apparatus applicable to the invention;

FIG. 2 is a view of a display panoramic visual image where a dorm room is depicted with the member's perspective indicated on the graphical representation;

FIG. 3 is a pictorial representation of the preferred apparatus for creating the panoramic visual images;

FIG. 4 is a screen display showing certain features associated with the internet-based implementation of the invention including an interactive checklist, dorm store, newsflash, etc.; and

FIG. 5 is a screen display showing a member menu that allows the member to organize and store personal information, create special listings, an option to schedule upcoming events and set a countdown clock/event reminder, and other features.

### DETAILED DESCRIPTION OF THE INVENTION

The following detailed description of the invention will focus on a preferred embodiment for use in conjunction with college students wishing to transition to and/or tour a college campus without the need for a physical visit. However, it will be appreciated by those of skill that the invention may be used in other situations, particularly those in which a prospective visitor or resident wishes to select a particular new environment or living institution from among a number of choices that would otherwise require a physical visit such as condominium communities, apartment complexes, nursing homes, hospices, summer camps, prep schools, assisted living facilities, builder homes, office buildings, hotels, industrial centers, rehabilitation centers, or the like. The preferred embodiment provides an interactive system that includes an internet website for use by a virtual community comprising college bound and college students, family and friends of students, merchants, colleges, and administrators in which the website is adapted to assist a prospective college student in the transition from living at home to living on a college campus.

The website provides the member with a virtual tour of the college campus, or other new environment, and a plurality of interactive features that are adapted to make transitioning to the new environment more enjoyable. The invention is made available via CD-ROM, floppy disc and/or most preferably online via an internet, intranet, or extranet website. Preferably, the invention provides a member with an on-line tour of a prospective new environment that is 360° spherical and/or stereoscopic and includes a plurality of other unique features that allows the member to quickly obtain information about everything they need and want to know about their potential new surroundings.

The tour is preferably digitally recorded on site at each dormitory for each school providing the service. The tour database can be arranged via schools and/or via geographic locations and/or via other selection criteria with each database preferably being internet accessible. Virtual tours of prospective new environments will preferably be viewed by clicking designated reference links at the website or via CD-ROMs which are given to prospective residents as part of an admissions package. The new environments according to the invention are temporary or permanent living/working environments such as college campuses, assisted living facilities, resorts, office buildings, or similar residences.

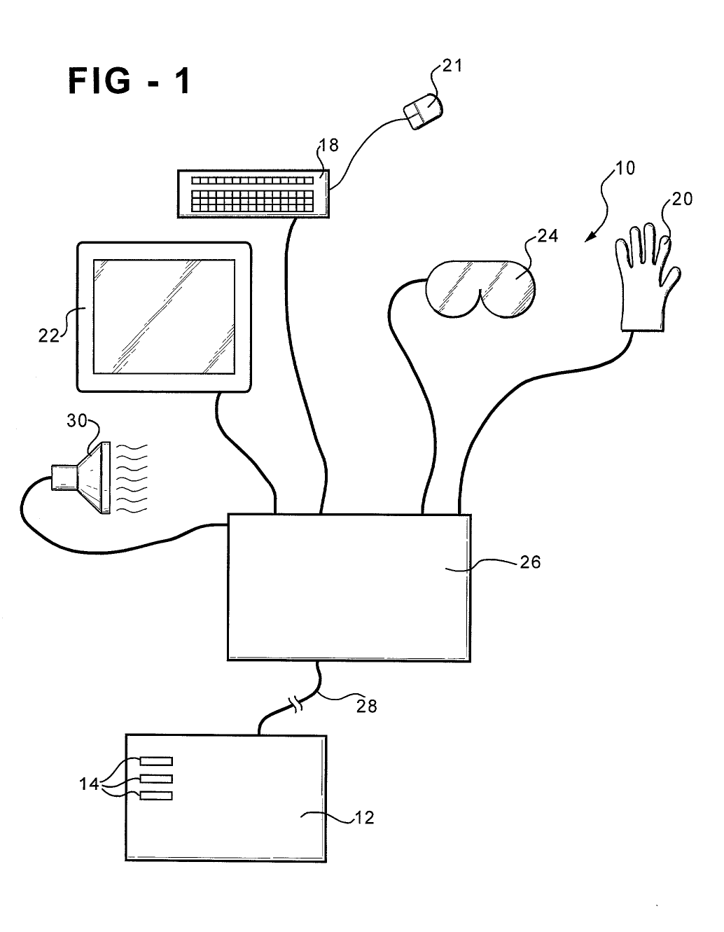

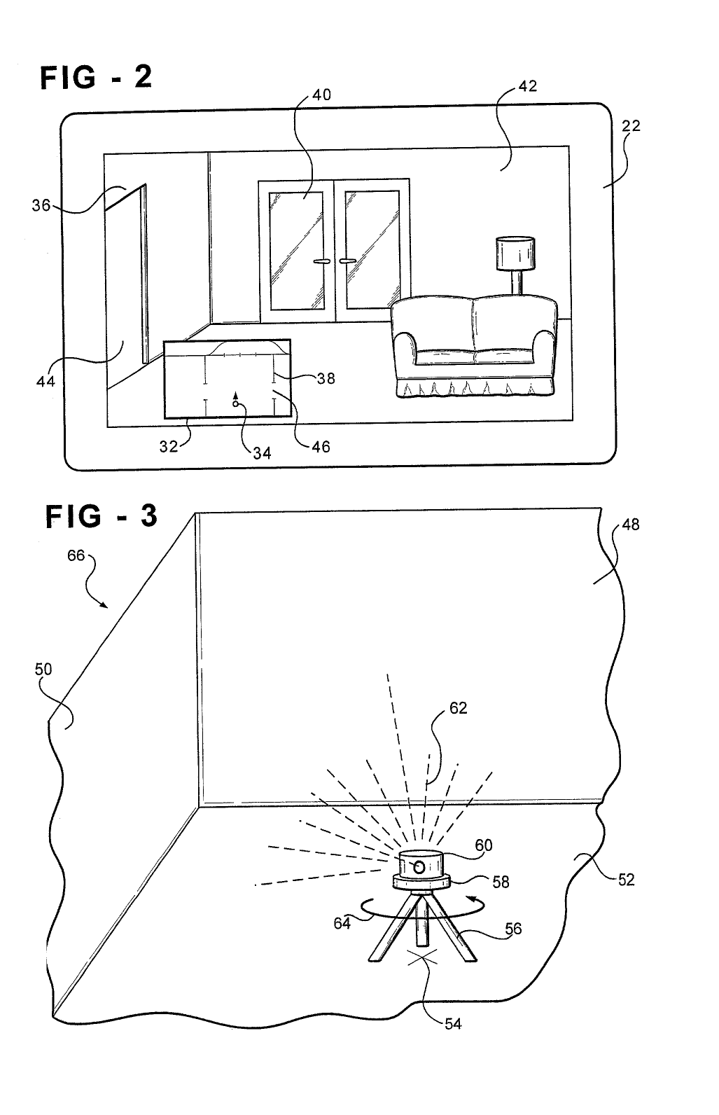

Hardware associated with the invention is shown generally at 10 in FIG. 1. The website includes a database 12 storing a set of panoramic visual images recorded from a particular perspective or camera position to provide a 360° panoramic tour of the dorm. For example, such panoramic visual images may be taken from an interior or exterior perspective as depicted in FIG. 2. As depicted in FIG. 3, position 54 represents a perspective of the camera 60.

Still referencing FIG. 3, camera 60 is rotated in the direction of arrow 64 in a standard increment of degrees such as 10°, 15° or 28° after recording an image until a series of photographs encompassing a full 360° are taken. Alternate embodiments may utilize a stepper motor in place of bracket 58 and utilize a rotatable tripod to automatically rotate the camera. The digital images from the camera are preferably recorded in a seamless panoramic series of images. Alternatively, the film may be used to capture the images that are subsequently stitched together to present the seamless panoramic image.

A variety of software programs are available to stitch the images together to create a 360° panoramic visual image. In an alternate embodiment, a panoramic camera may be utilized to record the images which may then be digitized, eliminating the need to stitch images together to create a single panoramic visual image.

The panoramic visual images are arranged in sets in database 12. Preferably, the panoramic camera is in network communication with the internet, extranet or other network such that the sets of the panoramic visual images 14 are downloaded directly into database 12 without use of a separate or removable storage medium.

Alternatively, the invention may utilize stereoscopic or three-dimensional images which are produced by recording two images, a left image corresponding to the view as seen by a member's left eye and a right image corresponding to a view as seen by a member's right eye. When the right image is displayed to the right eye and the left image is displayed to the left eye, the images are perceived stereoscopically. The images are displayed to the respective eyes through goggles thereby permitting a member to view the panoramic visual images stereoscopically. Alternatively, the images may be viewed stereoscopically through glasses which have a left lens which permits the left eye to view only the left image and having a right lens which permits the right to view only the right image.

Referring to FIG. 1, a personal computer is in electrical communication with database 12 via a phone line, DSL, cable modem or the like. The PC 26 includes input means such as a standing keyboard 18, mouse 21 or voice activation means (not shown). PC 26 also has display means such as screen 22. If screen 22 incorporates touch screen technology, screen 22 may be utilized as both input and display means. If the panoramic visual images were created so as to enable stereoscopic viewing, goggles 24 may be utilized to display the stereoscopic images and glove 20 may be utilized as input means.

Using the keyboard, a member may input a change perspective command which causes CPU 26 to display an additional image which corresponds to the new perspective requested by the member. Change perspective commands enable a member to look around a room within a dorm and perhaps move into other rooms as in the case of a suite. Alternatively, change perspective commands such as look left or look right may be input by moving a mouse to the left or right. Change perspective commands such as zoom in or zoom out are input utilizing the up and down arrow keys on a keyboard. Additionally, icons may be presented to the member which represent various change perspective commands. Clearly, each change perspective command may be input in a variety of ways which are acceptable in the present invention.

The viewing may additionally include an audio recording of a message the member will hear upon entering a particular room. As the member views any particular given panoramic visual image, an audio recording heard via speaker 30 will display the image the member sees. For example, a panoramic visual image displaying a unique aspect of the dorm such as placement of network or electrical outlets, placement of heating vents and so forth.

Preferably, the member accesses database 12 via a network such as the World Wide Web. In addition to personal computers, members may optionally access the network at cafes or public locations such as kiosks in any school commons or library.

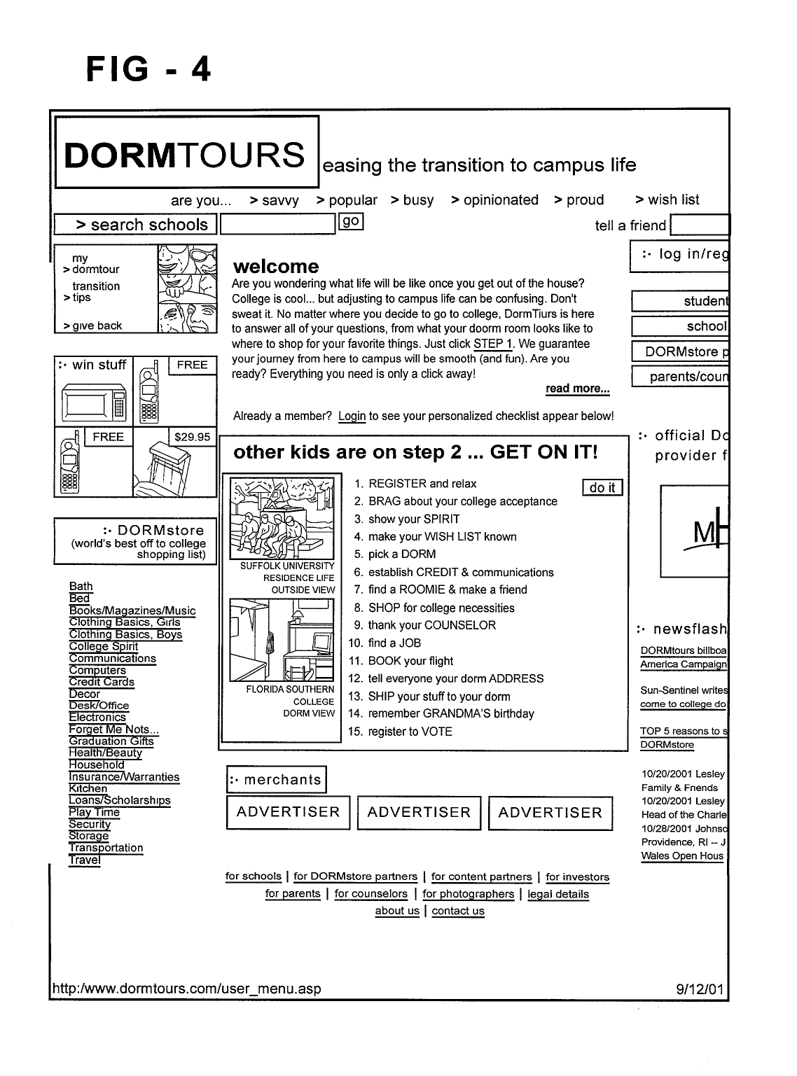

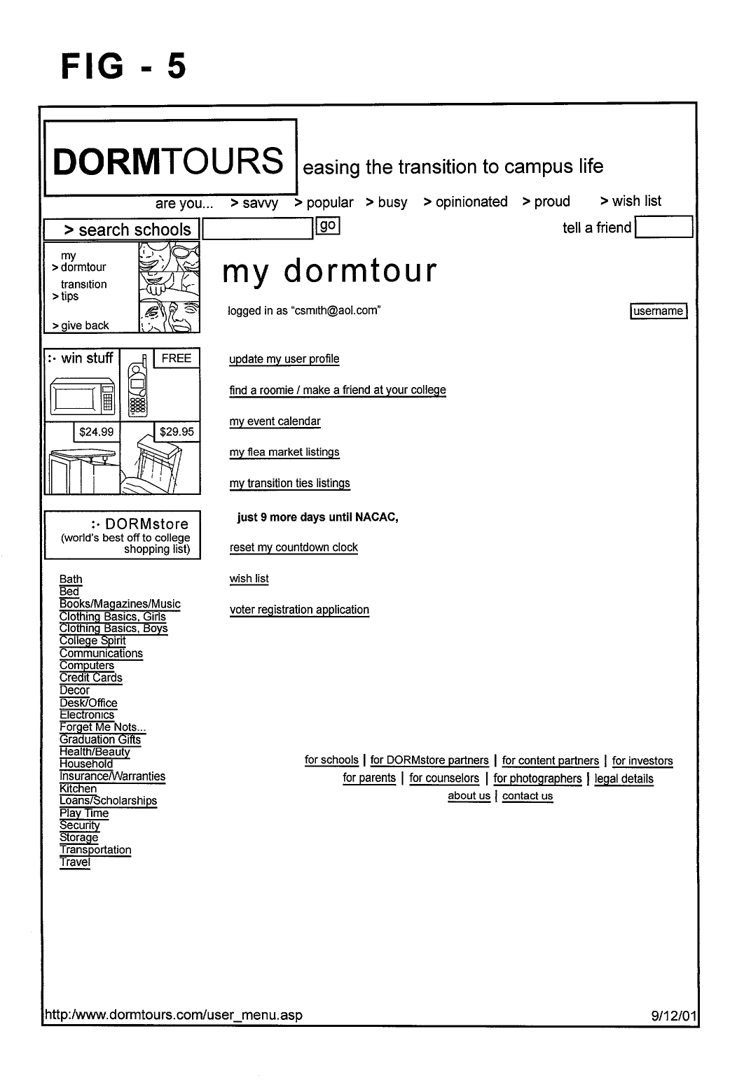

FIG. 4 illustrates an enhanced screen display showing an interactive checklist that includes predetermined lists of things a member will need to do during the transition and other things he/she may want to do to make the transition more enjoyable. The list may include line items such as thank your counselor, book a flight, remember grandma's birthday, establish a credit card, find a roomie, make a wish list, register to vote, pick a dorm, or even find a job among other things. In addition to the interactive checklist, a member menu is provided that includes a plurality of other interactive features as illustrated in FIG. 5. These features may include a dorm store feature whereby the member is provided with a plurality of links to merchant websites for e-shopping purposes, or the member may create a transition tips list accessible by other members which includes personal tips to help others in transitioning. Additionally, the member menu may allow the member to make a wish list that members can e-mail to family and friends, create a flea market listing whereby the member can create a list of items available for sale, play fantasy sports, schedule upcoming events, set a countdown clock/event reminder for upcoming events which will appear every time a member logs in, fill out a voter registration application, and/or modify a member profile.

Preferably, the interactive features according to the invention further include among other things brag cards and change of address cards in which the member's wish list can be attached and e-mailed to family and friends, and a “give back” feature.

Further, an enhanced dorm store feature allows members to print a list of all essential and nonessential items and links are provided for the member that directs them to merchant sites that carry these items. Once at the merchant's website, additional items offered by the merchant may be presented to the member to encourage the purchase of these items as well. This feature provides merchants with a convenient means to market their products and services to the website members while members are provided a means to e-shop for desired items which can be purchased and shipped to a desired location. A new newsflash section is also available where colleges can arrange to have some of their specific school events appear. With these enhanced interactive features, the present invention is organized around a position as the single comprehensive source to do everything needed to prepare for going away to college or other new living environment.

Generally speaking, this invention will increase the comfort level and allow freshmen and others entering college to make knowledgeable decisions about their housing by eliminating some of the unknowns. Additionally, it provides members with a convenient means to e-shop for immediate needs, to communicate with family and friends, to select a virtual tour of a prospective dormitory, to store personal information, to schedule and be reminded of things to do, and a means for colleges to post upcoming events specific to their school, amongst many other features. For example, the preferred embodiment includes a “give back” feature whereby members are encouraged to lend a helping hand to students and other kids. This feature allows members to assist financially challenged students by providing them with scholarships to cover various costs associated with transitioning. Further, the “give back” feature allows members to make cash donations or make arrangements to participate in community involvement/humanitarian projects such as programs to help abused and/or neglected children.

Maintenance of the website is facilitated by members of the virtual community, specifically the colleges, merchants, and website administrators. Each of these members is provided a unique authorization/access code that allows them to perform a plurality of functions specific to their needs relative to modifying, adding, deleting, inquiring, and analyzing information.

The foregoing figures and descriptions thereof are provided as illustrative of some of the preferred embodiments or the concepts of this invention. It is to be understood that various changes may be recognized by those skilled in the art and may be resorted to without departing from the spirit of the invention or scope of the claims as presented.

I claim:

1. An interactive system for use by a member of a virtual community, said interactive system allowing the member to access a website having a plurality of interactive features adapted to ease said member's transition to living in a new environment, said interactive features comprising:
a virtual reality viewing system for providing a virtual tour of the environment;
an interactive checklist, said interactive checklist including:
a first predetermined list of things a member should do during the transition; and
a second predetermined list of things said member may want to do during the transition in combination with said first predetermined list;
a member menu enabling a member to be selectively linked to one of a plurality of interactive resources; and
at least one link to a merchant website where members can e-shop for at least one item.

2. The system of claim 1 wherein the interactive features include a “give back” feature whereby members are encouraged to provide support to a desired college or institution through donations, scholarships, or community participation.

3. An interactive system for use by a virtual community comprising college bound and college students, family and friends of students, merchants, and colleges, said interactive system being adapted to assist a member of the virtual community in the transition to living on a college campus, said interactive system being further adapted to allow a member to access a website having a plurality of interactive features adapted to ease a member's transition, said interactive features comprising:
a virtual reality viewing system for providing a virtual tour of said college campus;
an interactive checklist, said interactive checklist including:
a predetermined list of things a member should do during the transition period; and
line items of things the member may want to do during the transition;
a member menu enabling a member to be selectively linked to one of a plurality of interactive resources; and
at least one link to a merchant website where members can e-shop for at least one item.

4. The system of claim 3 wherein the personalized checklist includes a member “registration” line item whereby initial visitors of the website can register to become members.

5. The system of claim 3 wherein the interactive checklist includes a “voter registration” line item.

6. The system of claim 3 wherein the interactive checklist includes a “change of address” line item.

7. The system of claim 6 wherein the “change of address” line item is adapted to allow the member to attach said wish list to the change of address.

8. The system of claim 7 wherein the “change of address” can be e-mailed to others.

9. The system of claim 3 wherein the interactive checklist includes a “shop for necessities” line item.

10. The system of claim 3 wherein the interactive features further include a “brag card” feature that allows members to create, e-mail, and print brag cards about the college campus.

11. The system of claim 3 wherein the “brag card” feature is adapted to allow the member to attach said wish list.

12. The system of claim 3 wherein the interactive features further include a “Dormstore” feature that allows the member to electronically shop for necessary items.

13. The system of claim 3 wherein the website further includes a “newsflash” section that allows authorized institutions to post information about specific events relative to the college campus.

14. The system of claim 3 wherein the merchants advertise products and services on the website.

15. The system of claim 14 wherein the merchants are provided an authorization to update advertisements on the website as desired.

16. The system of claim 3 wherein the interactive features includes a “shipping” feature that allows the member to make arrangements to have items shipped to/from the college campus.

17. The system of claim 3 wherein the interactive features include at least one contest to win prizes.

18. The system of claim 3 wherein the interactive checklist includes a “pick a dorm” line item.

19. The system of claim 3 wherein the interactive checklist includes a “make a wish list” line item.

20. The system of claim 3 wherein the virtual tour includes a virtual tour of at least one college dorm.

21. The system of claim 3 wherein the virtual community includes at least one administrator.

22. The system website of claim 3 wherein the at least one administrator is provided an authorization to manipulate, modify and perform maintenance on the website.

23. The system of claim 3 wherein said college is provided an authorization to update college information on the website.

24. The system of claim 3 wherein the interactive features include a “give back” feature whereby members are encouraged to provide support to a desired college or institution through donations, scholarships, or community participation.

25. The system of claim 3 wherein the member menu includes an events calendar that allows the member to schedule upcoming events.

26. The system of claim 3 wherein the member menu includes a flea market listing whereby the member can list items for sale or rent.

27. The system of claim 3 wherein the member menu includes a wish list feature whereby the member can make a list of items he/she wishes to have purchased for them.

28. The system of claim 3 wherein the member menu includes a transition tips listing whereby the member can create a list of personal tips for transitioning that is accessible by another member.

29. The system of claim 3 wherein the member menu includes a countdown clock that alerts the member to upcoming events.

30. A method of providing a prospective resident of a new environment with an interactive system adapted to assist said resident in transitioning to living in the new environment by allowing a member to interact with a virtual reality tour of the new environment and a plurality of interactive features made accessible at an internet website, said method comprising the steps of:
providing the member with a computer system adapted to access an interactive internet website;
providing an interactive website adapted to be accessed by a computer system connected to the internet;
including a virtual tour of a prospective new environment at the interactive website;
providing the member with access to the virtual tour;
including a plurality of interactive features at the website adapted to assist the member in transitioning to the new environment; and
providing at least one link at the interactive website that directs the member to a merchant website where the member can e-shop for at least one item.

31. The method of claim 30 wherein the step of including a plurality of interactive features further includes providing the member with a predetermined list of things that need to be done during transitioning.
